(19) United States
(12) Patent Application Publication
(10) Pub. No.: US 2014/0127417 A1
(43) Pub. Date: May 8, 2014

(54) System and Methods for Edge Sealing Medium Density Fiberboard (MDF) and Other Engineered Wood Laminates Using Powder and Liquid Coatings

(71) Applicant: Michael J. Chapman, Portsmouth, RI (US)

(72) Inventor: Michael J. Chapman, Portsmouth, RI (US)

(21) Appl. No.: 14/071,464

(22) Filed: Nov. 4, 2013

Related U.S. Application Data
(60) Provisional application No. 61/722,179, filed on Nov. 4, 2012.
(60) Provisional application No. 61/821,928, filed on May 10, 2013.

(51) Int. Cl. B27K 5/00

(52) U.S. Cl. CPC B27K 5/003
USPC 427/458; 118/58; 118/641; 118/621

(57) ABSTRACT

The present invention has to do with a method and system for coating and curing engineered wood products (EWP) in general, and the edges of EWPs in particular. One method for coating and curing medium density fiberboard (MDF) and other engineered wood laminates using coatings is provided.

### CROSS-REFERENCE TO RELATED APPLICATIONS

The present application is related to, claims the earliest available effective filing date(s) from (e.g., claims earliest available priority dates for other than provisional patent applications; claims benefits under 35 USC §119(e) for provisional patent applications), and incorporates by reference in its entirety all subject matter of the following listed application(s) (the “Related Applications”) to the extent such subject matter is not inconsistent herewith; the present application also claims the earliest available effective filing date(s) from, and also incorporates by reference in its entirety all subject matter of any and all parent, grandparent, great-grandparent, etc. applications of the Related Application(s) to the extent such subject matter is not inconsistent herewith:
1. U.S. provisional patent application 61/722,179 entitled “A System and Methods for Edge Sealing Medium Density Fiberboard and Other Engineered Wood Laminates Using Powder Coatings”, naming Michael J. Chapman as inventor, filed 4 Nov. 2012; and
2. U.S. provisional patent application 61/821,928 entitled “A System and Methods for Edge Sealing Medium Density Fiberboard and Other Engineered Wood Laminates Using Liquid and Powder Coatings”, naming Michael J. Chapman as inventor, filed 10 May 2013 (Atty. Docket VULC0001P1US).

### BACKGROUND

1. Field of Use

This invention relates to an improved apparatus for heating and curing powder coatings on porous wood products, such as medium density fiberboard (MDF). More specifically, the invention relates an improved catalytically powered oven employing a novel arrangement of infrared catalytic heaters for heating and curing powdered coatings on MDF board.

2. Description of Prior (Background)

For the past twenty-five years, the powder coating Of metal parts has become a popular method of finishing. There are numerous suppliers of the powder coating catering to all segments of the metal industry, ranging from automotive to architectual to marine applications. Powder on metal has become a mature industry. The principle method of applying powder to metal parts is to charge the powder particles with typically a charge via a spray gun. These charged particles are then attracted to metal parts that are earthed via a grounded hanging device on a conveying system.

Wood, or engineered wood products (EWP), such as medium density fiberboard (MDF) are not naturally as conductive as typical metal parts. MDF is made to become conductive by preheating the MDF to a range that is between about 150 and 250 degrees Fahrenheit. Preheating the MDF activates the moisture content of the MDF (typically about 5-10%) causing it to become conductive. Thus, charged powder will attach to a properly grounded MDF board.

Once the powder is attached to the board, the method of curing has been by either heating the powder in a convection oven for a certain period of time or by infrared heat for a period of time that is less than that of a convection oven. The infrared heat source has been either electric resistance heaters or catalytic heaters. In recent years, catalytic heaters have attracted considerable attention as the preferred choice of infrared heat sources.

Curing powder coatings on medium density fiberboard (MDF) using an infrared heat source has given rise to certain difficult problems. MDF board is available in various thicknesses ranging from one-quarter (¼) inch through to two inches, for example. With all thicknesses, the face surfaces of the MDF board are of a considerable higher density than the core of the board. The greater the thickness of the MDF board, the greater the difference is between the core density and the face surface density. MDF board has a certain amount of naturally occurring porosity within the board structure and hence a characteristic moisture content. The greater the thickness, the greater the porosity due to the lower core density.

When heating a piece of powder coated MDF board to cause the powder or liquid to cure, the board is typically hanging in a vertical position. As the board heats up, the entrapped moisture expands and out-gases through the edges of the board, typically from the center of the core in the area of lowest density. During the curing process using a conventional catalytic heating oven, the face surfaces of the board are easily heated, while the edges, especially the vertical edges, do not receive a full direct line of site of infrared energy. As a result, the edges of the board are the last to cure as compared to the face surfaces. This leads to an occurrence where the expanding moisture, which is out-gassing from inside the board, bubbles and forms blisters along the side edges of the board. These blisters occur because the powder at the edges has not reached a degree of cure, as compared to the face of the board, which would prevent the blisters from forming.

Furthermore, powder coatings, going through the curing process, first turn to liquid and then a gel stage followed by a curing stage where the powder reaches its full cured properties. However, the liquefied powder will be drawn into the edges of the MDF in a similar manner to edge grain on wood absorbing liquids. Thus, presenting an undesirable different look and feel to that of the coated and cured face sides of the MDF board and EWP's.

Depending on the method of cutting and sanding of the edges of the MDF board the wood fibers will protrude in varying degrees. The degree of this protrusion is dependent on the density across the board thickness and a number of other factors to do with the physical properties of the board—fiber type and length, percentage and type of glue used and the MDF board and the EWP's manufacturing process in general.

Thus, the manufacturing and pre-finishing processes for the MDF board, along with the precise application of the powder thickness on the edges, all contribute too many variables that may produce sub-standard edge finishes, resulting in waste and low yields.

To compensate for the issues associated with powder coating the edges of MDF boards the present state of the art employs a two coat process. First a powder prime coat is applied to the edges and faces of the MDF, partially cured, followed by a powder top coat and then the two coats are co-cured together. The end result provides an acceptable edge finish that mitigates, but doesn't eliminate the undesirable variables mentioned above.

It will be appreciated, that while it is only the edges of the MDF board that require the prime coat, the entire board is coated as part of the overall process; resulting in an unnecessary expenses since the primer coat adds no extra cosmetic benefit to the face sides of the MDF board. Additionally, there is the extra capital equipment cost of the primer powder application station and associated curing oven.

Thus, there exists a need for a system and method for the edge treatment of MDF boards and EWPs to maintain a high quality powder or liquid coated MDF board while reducing associated manufacturing expenses.

### BRIEF SUMMARY

The foregoing and other problems are overcome, and other advantages are realized, in accordance with the presently preferred embodiments of these teachings.

In accordance with one embodiment of the present invention a method for edge sealing medium density fiberboard (MDF) and other engineered wood laminates using powder or liquid coatings is provided. The method includes stacking a sufficient number of MDF boards face-to-face to achieve a weak electrostatic field emanating from the stack of MDF boards. Next, the MDF board edges are powdered coated with an oppositely charged powder and then cured with an approximately 300 degree Fahrenheit heat source.

The invention is also directed towards a powder or liquid coated production system comprising a conveyor track for conveying MDF boards with previously powder or liquid coated and cured edges through a pre-heat oven, a top coating station, and a curing oven.

The invention is also directed towards an alternate powder coating production system comprising a conveyor track for conveying engineered wood products through a pre-heat oven, a primer booth, a gel oven, a top coating station, and a curing oven.

In accordance with another embodiment of the present invention a method for edge sealing medium density fiberboard (MDF) and other engineered wood laminates using liquid coatings is provided. The method includes liquid coating MDF board edges before powder coating the entire MDF board.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a diagram layout of a MDF board powder coating production line in accordance with one embodiment of the present invention;

FIG. 2 is an illustration of an MDF board edge-coating, pre-conditioning process in accordance with an alternate embodiment of the present invention;

FIG. 3 is illustration of a curing oven for curing the edge coated MDF boards in accordance with the invention shown in FIG. 2;

FIG. 4 is an exploded view of one section of the MDF board stack illustration shown in FIG. 3;

FIG. 5 is a diagram layout of a MDF board powder coating production line for pre-conditioned MDF board edges in accordance with the present invention shown in FIG. 2 or FIG. 8;

FIG. 6 is a diagram layout of a MDF board powder or liquid edge-coating pre-conditioning and curing process production line in accordance with the present invention shown in FIG. 2 or FIG. 8;

FIG. 7 is an illustration of an MDF board liquid edge-coating pre-conditioning process in accordance with an alternate embodiment of the present invention;

FIG. 8 is illustration of a curing oven for curing the liquid edge coated MDF boards in accordance with the invention shown in FIG. 8; and

FIG. 9 is an exploded view of one section of the MDF board stack illustration shown in FIG. 8.

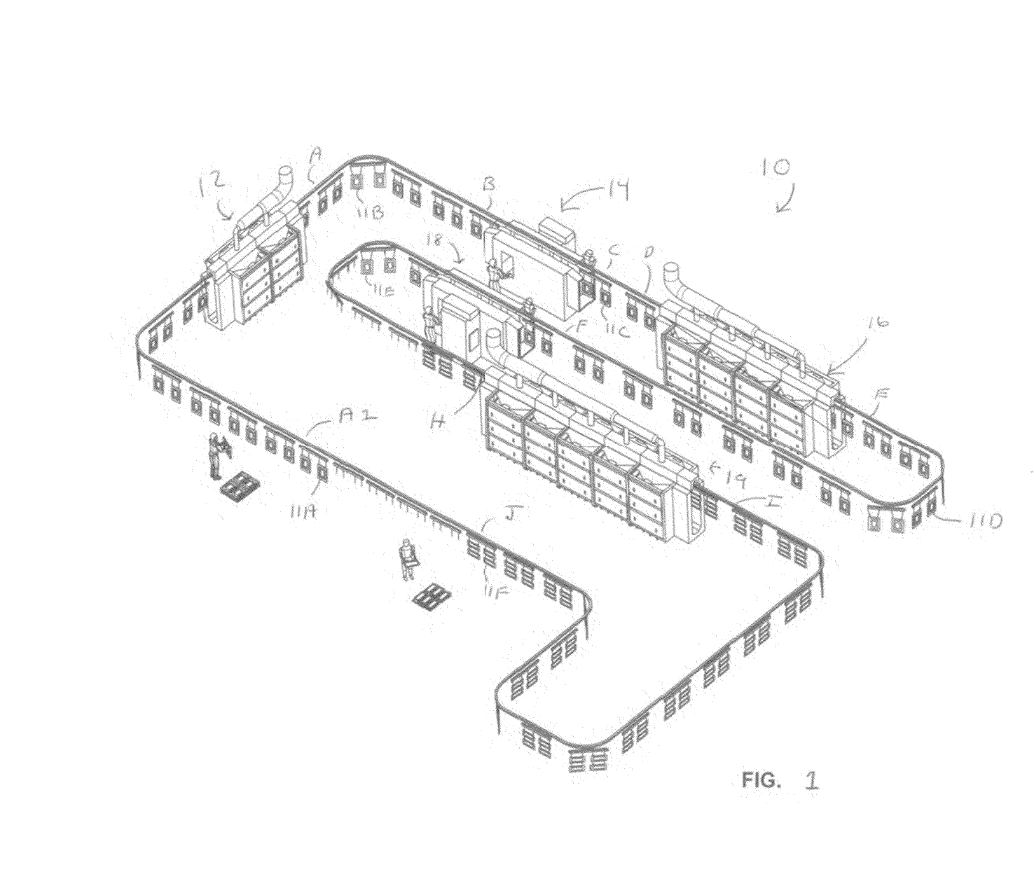

### DETAILED DESCRIPTION

The following brief definition of terms shall apply throughout the application:

The term “outer” or “outside” refers to a direction away from a user, while the term “inner” or “inside” refers to a direction towards a user;

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example; and

If the specification states a component or feature “may,” “can,” “could,” “should,” “preferably,” “possibly,” “typically,” “optionally,” “for example,” or “might” (or other such language) be included or have a characteristic, that particular component or feature is not required to be included or to have the characteristic.

The term “cure”, “cured” or “curing” shall be understood to mean the hardening of a suitable edge covering material. Further, curing may be brought about by chemical additives, ultraviolet radiation (UV), or applied heat.

Referring now to FIG, 1, there is shown a diagram layout of an EWP powder coating production line 10 for coating non pre-conditioned EWPs or MDF boards 11A. MDF boards 11A are mounted on continuously moving conveyor track 13 at point A1. It will be appreciated that any suitable EWP may be used and that MDF and EWP are often used interchangeably. The MDF board 11A is moved by conveyor track 13 to preheat oven 12. Preheat oven 12 heats the MDF board 11A to approximately 200 degrees Fahrenheit in approximately 1.5 minutes. It will be appreciated that the conveyor track 13 can operate at any suitable line speed. For example, the conveyor track can continuously operate at a speed of 6 feet per minute.

Preheated MDF board 11B exiting preheat oven 12 at point A is at approximately 200 degrees Fahrenheit and thus conductive which allows powder to electrostatically adhere to the board. Conveyor track 13 moves preheated board 11B from point A to point B in about 2 minutes where the preheated MDF board 11B enters primer booth 14 at approximately 100 degrees Fahrenheit.

Primer booth 14 electrostatically epoxy powder coats the face and edges of MDF board 11B in approximately 1.5 minutes. Exiting primer booth 14 the primed MDF board 11C is conveyed by conveyor track 13 from point C to point D in approximately 2 minutes where the primed MDF board 11C enters a 3-section infrared gel oven 16 described in U.S. Pat. No. 7,159,535 and incorporated herein. In approximately 3 minutes the 3-section infrared gel oven 16 heats the primed MDF board 11C to approximately 300 degrees Fahrenheit causing the epoxy powder on the MDF board 11C to gel or partially liquefy.

Exiting the gel oven 16, the gelled MDF board 11D is conveyed from point E to point F by conveyor track 13 in approximately 8 minutes where the gelled MDF board 11D enters the top coat booth 18 at approximately 130 degrees Fahrenheit. The top coat booth 18 top coats the gelled MDF board 11D with another powder layer on all faces and edges of the gelled MDF board 11D in approximately 1.5 minutes.

Exiting the topcoat booth 18 at point G the top coated MDF board 11E is conveyed to point H where the board 11 E enters the 4-section cure oven 19. The 4-section cure oven 19 heats the top coated MDF board 11E to approximately 300 degrees Fahrenheit in approximately 5.5 minutes which cures and hardens the previously applied primer coat and the previously applied top coat.

Exiting the 4-section cure oven 19 at point I the cured MDF board 11F is conveyed to point J in approximately 20 minutes allowing for the cured MDF board 11F exiting the cure oven 19 at approximately 300 degrees Fahrenheit to air cool. At point J the cooled and cured MDF board 11F is removed from conveyor track 13.

Referring also to FIG. 2 there is shown an illustration of a MDF board edge coating preconditioning process in accordance with an alternate embodiment of the present invention. The production of the MDF boards 21 is generally via a CNC routing machine (not shown) that has cut and sized the board with the required edge profile 24A. Once removed from the CNC machine the MDF board 21 is stacked such that all the edges 24A line up to form a block of MDF boards. The MDF board stack is typically 48″ tall but may be shorter or taller. The thickness of the MDF board is that which is commercially available ranging from 6 mm to 35 mm.

Once the MDF stack 28 is complete it is placed on a fixed or rotating plate 23 that may be grounded or earthed through turntable 22, a sacrificial plate 26 that may be grounded is placed on the top of the stack to help prevent overspray powder from coating the top surface of the stack 28.

Using an electrostatic powder application equipment 29, powder 25 is applied directly to the MDF board edges 24A to the required thickness. Since the MDF boards 21 are stacked face to face with only the edges 24A exposed, powder is only deposited on these exposed edges.

Referring also to FIG. 3 there is shown an illustration of a curing oven for curing the edge coated MDF boards in accordance with the invention. Once the MDF board edge powder application is complete, the assembled stack 27 is subject to a heat source sufficient to cure the powder.

The heating oven 40 shown in FIG. 3 includes six heating panels 42. Each of the heating panels 42 may further consist of separate heating elements 42A-42D, where each heating element may be independently operated at a different temperate to provide a temperature gradient from the top of the heating panel to the bottom of the heating panel. It will also be appreciated that any suitable number of heating panels 42 may be used. The preferable heat source is infrared, electric or gas derived infrared energy. Hot air generated convection heat may also be used. The heat source is directed at the stacked edges of the boards, which, depending on the heating process, may be rotating in front of the heat source,

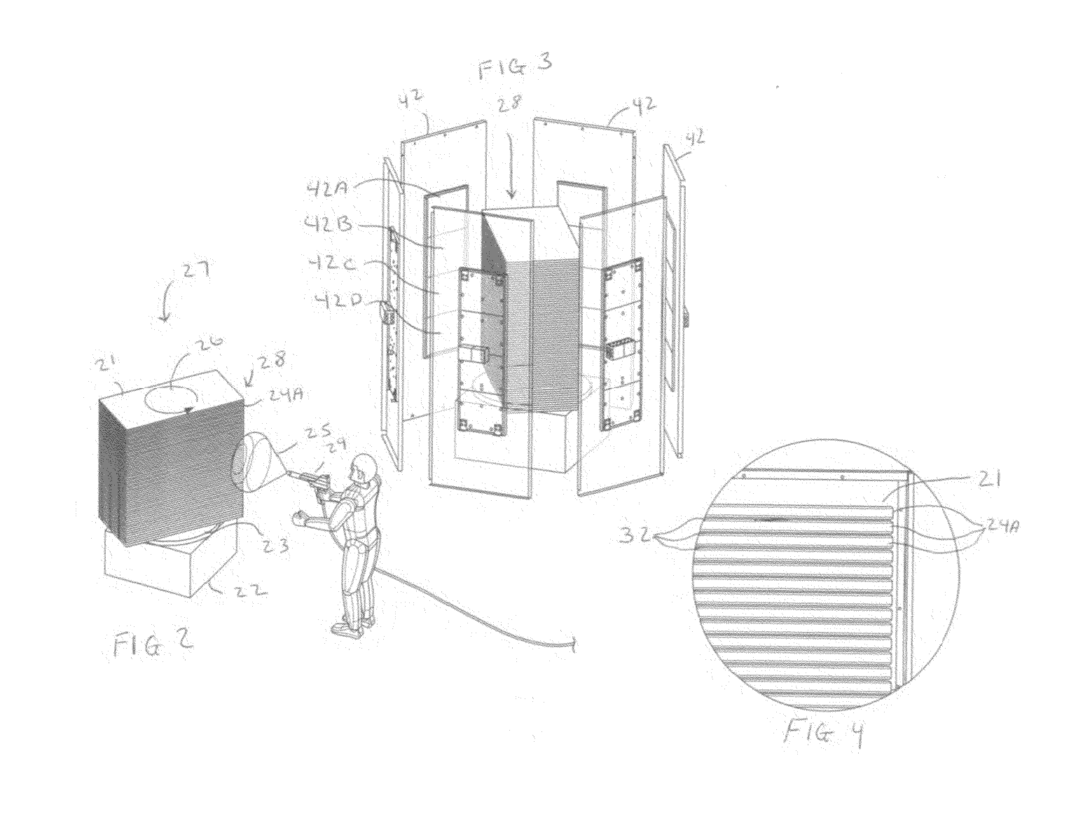

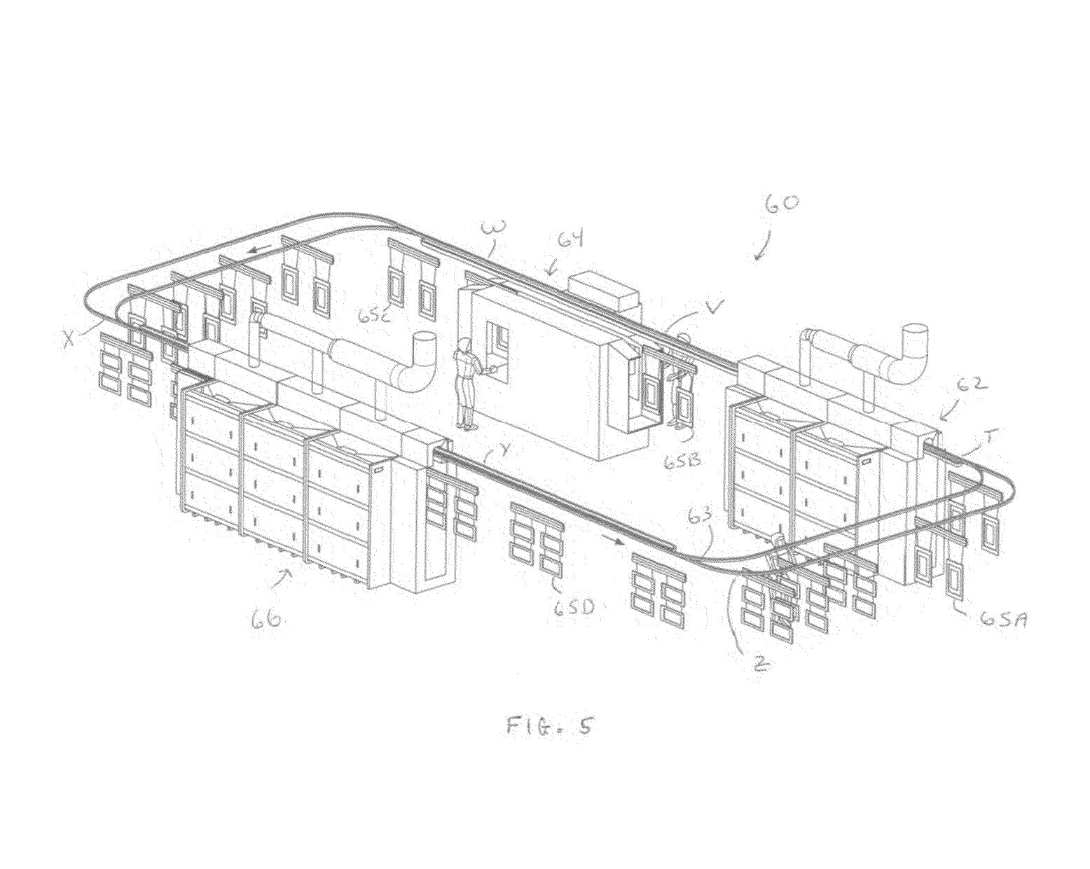

Referring also to FIG. 4 there is shown an exploded view of one section of the MDF board stack 28 illustration shown in FIG. 3. Depending on the type of MDF board or EWP edge profile, it may be necessary to separate the MDF boards 21 with a thin sheet of material 32 that may be conductive. This is to prevent the MDF boards 21 from sticking together once the powder has cured.

Once the powder coating has gelled or cured, the MDF board stack 28 may undergo a sanding process to remove any coated fibers that may be protruding from the unified exposed edges. After this process the boards are now ready to be hung on the powder coating line and receive the final top coat and undergo a final cure.

Once the MDF board edge powder coating has cured and cooled, the MDF board stack 28 may undergo a sanding process to remove any coated fibers that may be protruding from the unified exposed edges. After this process the boards are now ready to be hung on the powder coating line and receive the final top coat and undergo a final cure.

Referring also to FIG. 5, there is shown a modified powder coating production line 60 for powder coating pre-conditioned EWPs or MDF boards 65A. MDF boards 65A, having edges pre-powder coated and cured are mounted on continuously moving conveyor track 63 at point T. The MDF board 65A is moved by conveyor track 63 to preheat oven 62. Preheat oven 62 heats the MDF board 65A to approximately 200 degrees Fahrenheit in approximately 1.5 minutes.

The pre-heated MDF board 65B is conveyed from point U to point V by conveyor track 63 in approximately 2-3 minutes where the preheated MDF Board enters the top coat booth 64 at approximately 130 degrees Fahrenheit. The top coat booth 64 top coats the pre-heated MDF board 65B with a topcoat powder layer on all faces and edges of the MDF board 65B in approximately 1.5 minutes.

Exiting the topcoat booth 64 at point w the top coated MDF board 65C is conveyed to point X where the board 65C enters the 3-section cure oven 66. The 3-section cure oven 66 heats the top coated MDF board 65C to approximately 300 degrees Fahrenheit in approximately 5.5 minutes which cures and hardens the previously applied top coat.

Exiting the 3-section cure oven 66 at point Y the cured MDF board 65D is conveyed to point Z in approximately 20 minutes allowing for the cured MDF board 65DF exiting the cure oven 66 at approximately 300 degrees Fahrenheit to air cool. At point Z the cooled and cured MDF board 650 is removed from conveyor track 63.

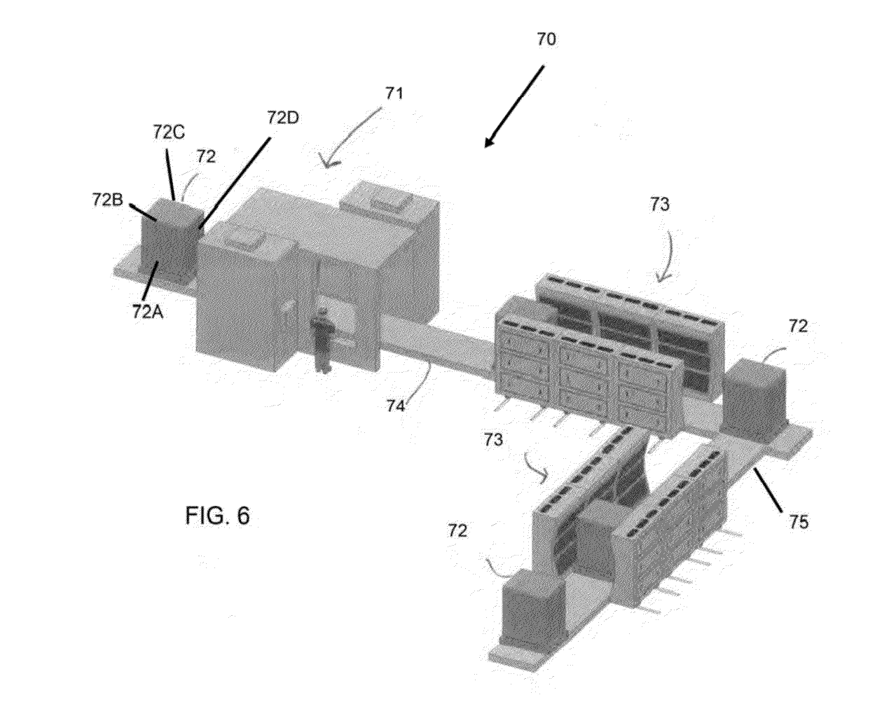

Referring also to FIG. 6 there is shown a diagram layout of a MDF board edge-coating pre-conditioning and curing process production line 70 in accordance with the present invention shown in FIG. 2 or FIG. 8. The MDF boards (FIG. 2-21) are stacked such that all the edges line up to form a block of MDF boards 72. The MDF board stack 72 is typically 48″ tall but may be shorter or taller. For example, the stack may comprise one MDF board or MDF piece. The thickness of an MDF board is that which is commercially available ranging from 6 mm to 35 mm.

The MDF stack 72 is conveyed via track 74 to precondition station 71 where the edges of the boards are coated with powder or liquid as discussed herein. The stack is then conveyed to oven 73 where the powder (or liquid primer) on two sides 72A and 72C is cured for approximately 4 minutes. It will be understood that curing time will depend upon the primer type in use. Block 72 is then conveyed via perpendicular track 75 to oven 73 where the edges 72B and 72D are cured for approximately 4 minutes. It will be appreciated that powder, or liquid, is cured on the edges of block 72 without developing heat inside the board (FIG. 2-21) that in prior art causes the moisture to vaporize and migrate towards the edges. Thereby causing out gassing through the prior art molten powder prior to the gel and cure stage of the powder.

In alternate embodiments FIG. 6 may be represented as a high speed MDF board edge-coating pre-conditioning and curing process production line that sands, liquid coats, or primes, the MDF board edge, and cures the liquid all in one pass. In this embodiment fast processing equipment treats one edge at a time and the MDF board is returned back to the beginning and then another edge is treated and so on until all the edges are finished.

It will be understood that the liquid primer may be cured by any suitable method, such as heat curing, for example; or, by chemical reaction from catalyst curing and accelerators. It will be also be understood that the liquid primer may be any suitable liquid primer such as PVA glue or other solvent based liquid such as, for example, a lacquer or enamel based primer. It will also be understood that the liquid primer may be a suitable water based primer.

Property characteristics of a suitable primer, water based or solvent based, include, but are not limited to, the capacity to be cured prior to any liquid induced deformation of the MDF board; and, after curing, sufficient mechanical strength (which may be measured by hardness, toughness, stiffness and/or creep, or strength) to resist any deformation of the cured primer due to out-gassing or water vaporization discussed earlier.

Suitable primers, water or solvent based, may also include particulate matter such as resins, polymerized synthetics or chemically modified natural resins including thermoplastic and/or thermosetting polymers. Suitable primers may also include amorphous solid particulate matter, such as, for example, glass or nanostructured materials, which may or may not, exhibit glass-liquid transition.

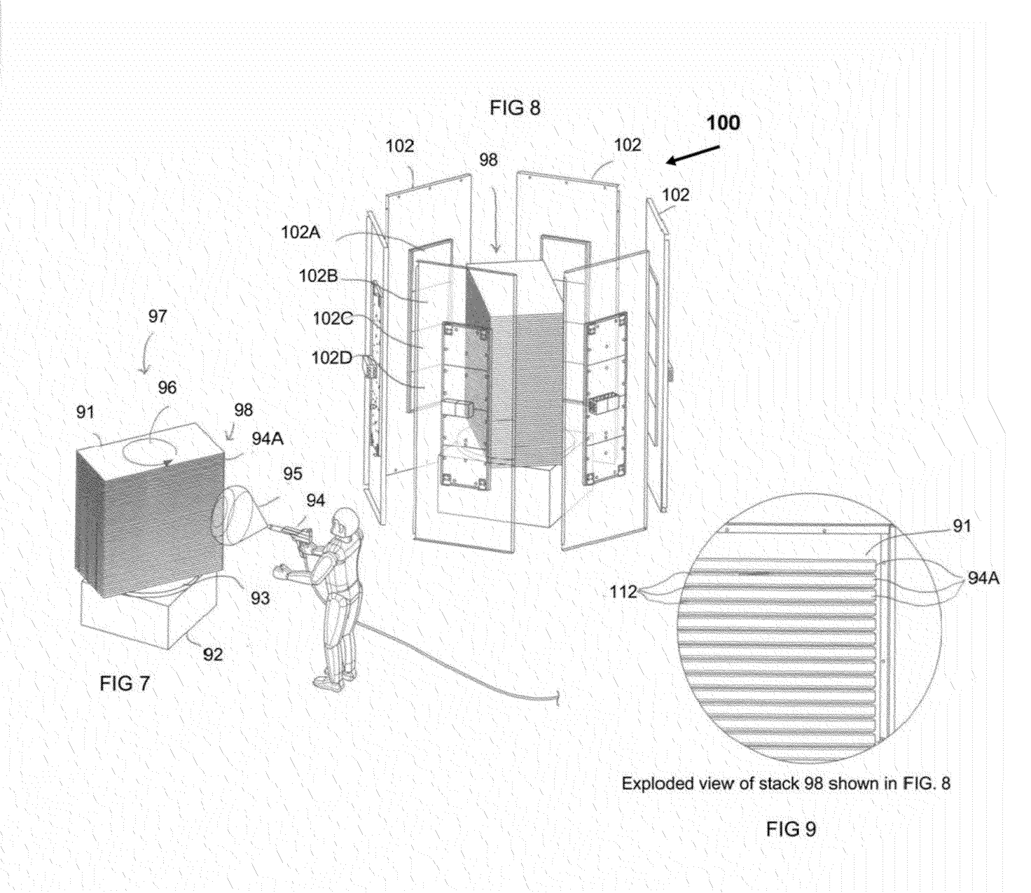

Referring also to FIG. 7 there is shown an illustration of a MDF board liquid edge coating preconditioning process in accordance with an alternate embodiment of the edge coating primer aspect of the present invention. The production of the MDF boards 91 is generally via a CNC routing machine (not shown) that has cut and sized the board with the required edge profile 94A. Once removed from the CNC machine a plurality of the MDF boards 91 are stacked such that all the edges 94A line up to form a stack 97 of MDF boards. The MDF board stack is typically 48″ tall but may comprise any suitable number of MDF boards. The thickness of the MDF board is that which is commercially available ranging from 6 mm to 35 mm.

Once the MDF stack 28 is complete it is placed on a fixed or rotating plate 93 that may be grounded or earthed through turntable 92, a sacrificial plate 96 that may be grounded is placed on the top of the stack to help prevent overspray from coating the top surface of the stack 98.

An electrostatic paint, in the form of either powdered particles or atomized liquid, is initially projected towards the conductive stack 98 using normal spraying methods, and is then accelerated toward the work piece by an electrostatic charge via application equipment 29. Liquid primer 95 is applied directly to the MDF board edges 94A to the required thickness. Since the MDF boards 91 are stacked face to face with only the edges 94A exposed, liquid primer is only deposited on these exposed edges. It will also be appreciated that any suitable liquid primer may be used, including non-electrostatic liquid primer.

Referring also to FIG. 8 there is shown an illustration of an alternate curing oven for curing the liquid edge coated MDF boards in accordance with the invention. Once the MDF board edge liquid primer application is complete, the assembled stack 97 is subject to a curing method such as, for example, a heat source sufficient to cure the liquid.

It will be understood that the liquid primer may be any suitable liquid primer such as PVA glue or other solvent based liquid such as, for example, a lacquer or enamel based primer.

The heating oven 100 shown in FIG. 8 includes six heating panels 102. Each of the heating panels 102 may further consist of separate heating elements 102A-42D, where each heating element may be independently operated at a different temperate to provide a temperature gradient from the top of the heating panel to the bottom of the heating panel. It will also be appreciated that any suitable number of heating panels 102 may be used. Any suitable heat or light source may be used to cure the liquid primer, such as, for example, infrared, electric, gas derived infrared energy, and Ultra Violet (UV) radiation sources. Hot air generated convection heat may also be used. The heat source is directed at the stacked edges of the boards, which, depending on the beating process, may be rotating in front of the heat source.

It will be understood that the liquid primer may be cured by any suitable method, such as heat curing, for example; or, by chemical reaction from catalyst curing and accelerators.

Referring also to FIG. 9 there is shown an exploded view of one section of the MDF board stack 98 illustration shown in FIG. 8. Depending on the type of MDF board or EWP edge profile, it may be necessary to separate the MDF boards 91 with a thin sheet of material 112 that may be conductive. This is to prevent the MDF boards 91 from sticking together once the powder has cured.

Once the liquid coating has gelled or cured, the MDF board stack 98 may undergo a sanding process to remove any coated fibers that may be protruding from the unified exposed edges. After this process the boards are now ready to be hung on the powder coating line and receive the final top coat and undergo a final cure as described earlier.

It will be appreciated that pre-conditioning the edges of the MDF boards as described herein offers several advantages. One is the reduction of the number of stations required to powder coat and cure a MDF board (or other EWP products.) This in turn results in significant cost savings associated with labor and capital equipment costs. For example, an infrared catalytic heating source typically uses the very rare, and very expensive, metal platinum as the catalyst for converting natural gas to infrared heat. Thus, reducing the number of stations where platinum is a primary component also reduces the cost of the powder coating production line.

Another advantage associated with pre-conditioning the MDF boards is time savings. The MDF boards can be pre-conditioned independently of the powder coating production line and stored while awaiting top coating. Thus, if the main powder coating line is offline due to maintenance or malfunctions, the pre-conditioning process can continue, thereby minimizing production impacts due to maintenance or malfunctions.

Yet another advantage is the pre-conditioned MDF boards require less powder during the powder coating production process since the faces of the boards, the majority of the surface area of the boards, are only powder coated once as compared with MDF boards not pre-conditioned.

Still another advantage of the invention is that the pre-conditioned MDF board edges will not lead to an occurrence where expanding or outgassing vapor forms blisters along the side edges of the board when the pre-conditioned MDF board is only top coated and cured.

It should be understood that the foregoing description is only illustrative of the Invention. Thus, various alternatives and modifications can be devised by those skilled in the art without departing from the invention. For example, the EWP boards are often flat, however the same application technique applies to molded EWP components as in the case of molded plywood seats that are also stacked to expose the multiple layers of edges in a similar uniform fashion. Accordingly, the present invention is intended to embrace all such alternatives, modifications and variances that fall within the scope of the appended claims. For example, any engineered wood product (EWP) haying non-uniform densities may be edge coated as described herein.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Finally, it will be understood that use of broader terms such as comprises, includes, and having should be understood to provide support for narrower terms such as consisting of, consisting essentially of and comprised substantially of Use of the term “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

What is claimed is:

1. A production line for producing coated engineered wood products (EWP) having a plurality of edges and faces, the production line comprising:
a preheating station;
a top-coating station for coating the heated EWP in approximately 1.5 minutes;
a cure oven station for curing the coated EWP; and
a conveyor track system for transporting the EWP to the preheating station, from the preheating station to the top-coating station, from the top-coating station to the cure oven station, from the cure oven station to an unload station.

2. The production line as in claim 1 wherein the preheating station further comprises an infrared oven for heating the EWP to substantially 200 degrees Fahrenheit in approximately 1.5 minutes.

3. The production line as in claim 2 wherein the cure oven station further comprises a second infrared oven for heating the coated EWP to substantially 300 degrees Fahrenheit in approximately 5.5 minutes.

4. The production line as in claim 1 further comprising:
a primer station for electrostatically pre-coating the EWP in approximately 1.5 minutes;
a gel oven station; and
the conveyor track system for transporting the EWP from the preheating station to the primer station, from the primer station to the gel oven station, from the gel oven station to the top-coating station.

5. The production line as in claim 4, wherein the gel oven station further comprises a third infrared oven for heating the coated EWP to substantially 300 degrees Fahrenheit causing the coating to gel or partially liquefy.

6. The production line as in claim 1 further comprising a pre-edge coating station for edge coating at least one of the plurality of EWP edges, the pre-edge coating station comprising;
a grounded platform for electrically grounding the plurality of EWP edges, and wherein at least one of the plurality of edges of the electrically grounded EWPs are electrostatically coated; and
a fourth infrared oven for curing the at least one of the plurality of electrostatically coated edges.

7. The production line as in claim 6 wherein the electrostatic coating comprises a powder electrostatic coating.

8. The production line as in claim 6 wherein the electrostatic coating comprises a liquid electrostatic coating.

9. A production line for producing coated engineered wood products (EWP) having a plurality of edges and faces, the production line comprising:
a preheating station for heating the EWP to an electrostatic conductive phase;
a primer station for electrostatically pre-coating the EWP, wherein the primer station comprises:
a grounded platform for electrically grounding the plurality of EWP edges, and wherein at least one of the plurality of edges of the electrically grounded EWPs are electrostatically coated; and
an edge curing oven for curing the at least one of the plurality of electrostatically coated edges,
a gel oven station for gelling the electrostatically pre-coated EWP;
a top-coating station for electrostatically over coating the gelled EWP;
a cure oven station for curing the over coated EWP; and
the conveyor track system for transporting the EWP from the preheating station to the primer station, from the primer station to the gel oven station, from the gel oven station to the top-coating station, from the top-coating station to the cure oven station, from the cure oven station to an unload station.

10. The production line as in claim 9 wherein the preheating station, the edge curing oven, the gel oven station, and the cure oven station each comprise at least one infrared oven.

11. The production line as in claim 10 wherein each infrared oven comprises a catalytic infrared oven.

12. The production line as in claim 9 wherein the cure oven station comprises at least one ultra-violet (UV) cure station.

13. The production line as in claim 9 wherein the electrostatic coating comprises a powder electrostatic coating.

14. The production line as in claim 9 wherein the electrostatic coating comprises a liquid electrostatic coating.

15. A method for edge sealing medium density fiberboard (MDF) to prevent undesirable blistering, the method comprising:
applying a coating to at least one edge of the MDF, wherein the coating is selected from the group consisting of thermoset plastic and thermoplastic.

16. The method as in claim 15 wherein applying the coating to the at least one edge of the MDF further comprises:
heating the MDF to a predetermined temperature; and
electrostatically coating the at least one edge.

17. The method as in claim 16 further comprising curing the coating, wherein curing is selected from the group consisting of infrared curing, thermal curing, chemical curing and ultra-violet (UV) curing.

18. The method as in claim 17 wherein infrared curing further comprises adapting a catalytic oven to provide infrared curing of the edge coated MDF.

19. The method as in claim 18 wherein adapting a catalytic oven to provide infrared curing of the edge coated MDF further comprises adapting the catalytic oven to heat the edge coated MDF to approximately 300 degrees Fahrenheit.
